(19) United States
(12) Patent Application Publication
(10) Pub. No.: US 2015/0054981 A1
(43) Pub. Date: Feb. 26, 2015

(54) METHOD, ELECTRONIC DEVICE, AND COMPUTER PROGRAM PRODUCT

(71) Applicant: KABUSHIKI KAISHA TOSHIBA, Tokyo (JP)

(72) Inventors: Kohji Saiki, Kawasaki-shi (JP); Yuuji Irimoto, Fussa-shi (JP); Daisuke Hirakawa, Saitama-shi (JP)

(73) Assignee: KABUSHIKI KAISHA TOSHIBA, Tokyo (JP)

(21) Appl. No.: 14/214,007

(22) Filed: Mar. 14, 2014

(30) Foreign Application Priority Data
Aug. 23, 2013 (JP) 2013-173939

(51) Int. Cl. H04N 1/32; H04N 5/232

(52) U.S. Cl. CPC H04N 1/32128; H04N 5/23293
USPC 348/231.5

(57) ABSTRACT

According to one embodiment, a method includes: storing image data acquired by a camera in an electronic device, first information regarding a date and time at which the image data is acquired, and second information regarding a position at which the image data is acquired; acquiring third information regarding a first position at which the electronic device is present; and displaying, when the electronic device is in a first region comprising the first position, first image data acquired by the camera in the first region based on a photographing interval in the first region.

### CROSS-REFERENCE TO RELATED APPLICATIONS

This application is based upon and claims the benefit of priority from Japanese Patent Application No. 2013-173939, filed Aug. 23, 2013, the entire contents of which are incorporated herein by reference.

### FIELD

Embodiments described herein relate generally to a method, an electronic device, and a computer program product.

### BACKGROUND

Conventionally, there has been a tendency that a camera module is mounted to a user-portable electronic device, such as a mobile phone, a smart phone, and a tablet terminal. Accordingly, users tend to take photographs at various places.

There has been a tendency that a user possesses a large number of pieces of image data because the user take photographs at many places by an electronic device to which a camera module is mounted according to the conventional technique. However, it is difficult to look over the large number of pieces of image data he/she possesses.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating an example of an external appearance of a smart phone according to a first embodiment;

FIG. 2 is an exemplary diagram illustrating an example of a system configuration of the smart phone in the first embodiment;

FIG. 3 is an exemplary diagram illustrating a software configuration implemented by the smart phone in the first embodiment;

FIG. 4 is an exemplary diagram illustrating an example of dividing an area in the first embodiment;

FIG. 5 is an exemplary diagram illustrating an example of the table structure of an area information DB in the first embodiment;

FIG. 6 is an exemplary diagram illustrating an example of the table structure of an image data managing module in the first embodiment;

FIG. 7 is an exemplary diagram illustrating an example of the motional frequency and the photographing interval of the smart phone in the first embodiment;

FIG. 8 is an exemplary diagram illustrating an example of a screen displayed by a display controller in the first embodiment;

FIG. 9 is an exemplary flowchart of display process of acquired image data in the smart phone in the first embodiment; and

FIG. 10 is an exemplary diagram illustrating a software configuration 1000 implemented by a smart phone according to a second embodiment.

### DETAILED DESCRIPTION

In general, according to one embodiment, a method comprises: storing, in a storage module, image data acquired by an image acquiring module provided to a camera in an electronic device, first information about regarding a date and time at which the image data is acquired, and second information about regarding a position at which the image data is acquired; acquiring third information regarding a first position at which the electronic device is present; and displaying, when the electronic device is in a first region comprising the first position, the first image data acquired by the camera in the first region based on a photographing interval in the first region

The following describes embodiments related to a method, an electronic device, and a computer program with reference to the accompanying drawings.

### First Embodiment

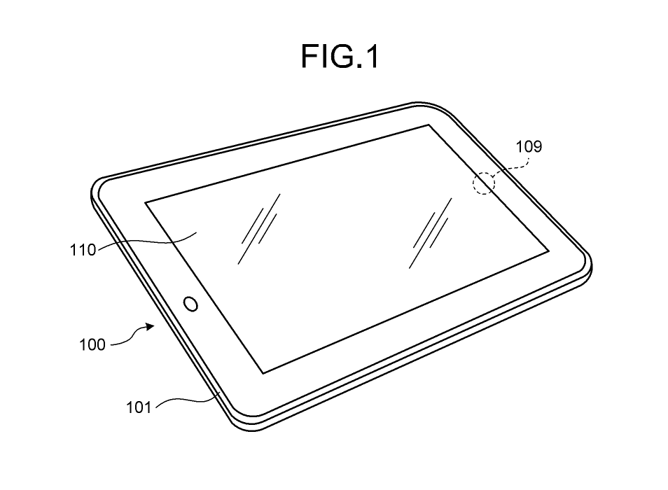

FIG. 1 is a perspective view illustrating an example of the external appearance of a smart phone according to a first embodiment. The embodiment illustrated in FIG. 1 describes an example of using the smart phone as an electronic device. The first embodiment does not limit the electronic device to the smart phone. Alternatively, the electronic device may be a tablet computer, a cellular telephone terminal, a PDA, a laptop personal computer, or the like. As illustrated in FIG. 1, this smart phone 100 comprises a body 101, a touch screen display 110, and a camera module 109.

The body 101 has a thin rectangular parallelepiped box shape. The touch screen display 110 is fitted onto one surface of the body 101. For example, the touch screen display 110 is configured such that a touch panel is attached to a liquid crystal display (LCD). The LCD displays characters, images, and the like on a screen. The touch panel receives an operation from a user by detecting a contact position of a pen or a finger on a screen displayed by the LCD. The first embodiment does not limit the display module to the LCD as long as it can display characters, images, and the like. Any type of a touch panel may be used, and for example, a capacitive touch panel may be used.

The camera module 109 is provided to a surface (back face) of the body 101 opposite the surface to which the touch screen display 110 is provided so as to image the surroundings of the smart phone 100.

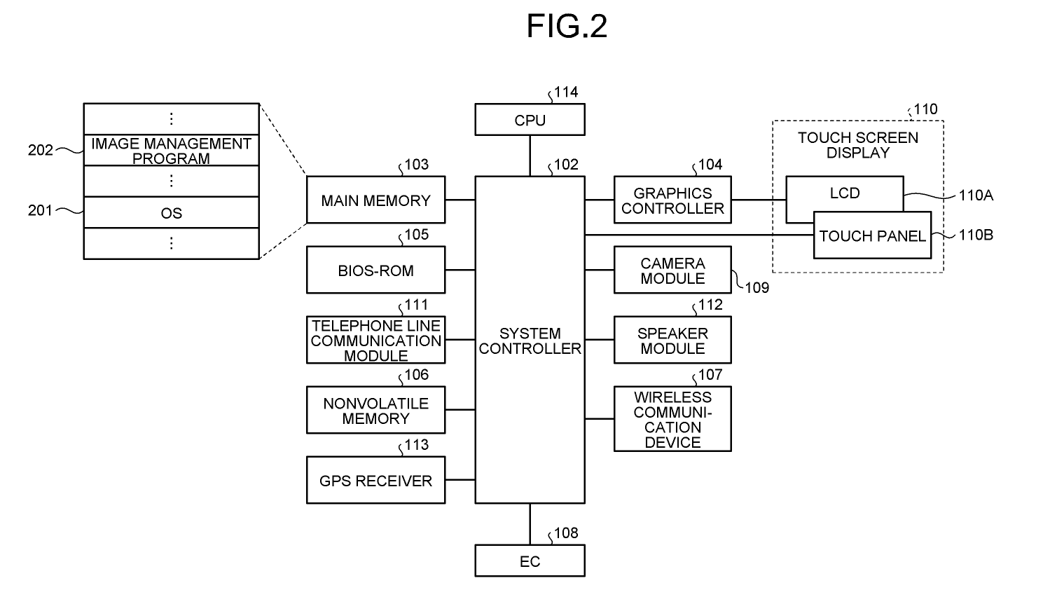

FIG. 2 is a diagram illustrating a system configuration example of the smart phone 100. As illustrated in FIG. 2, the smart phone 100 comprises a central processing unit (CPU) 114, a system controller 102, a main memory 103, a graphics controller 104, a BIOS-ROM 105, a nonvolatile memory 106, a wireless communication device 107, an embedded controller (EC) 108, the camera module 109, a telephone line communication module 111, a speaker module 112, and a global positioning system (GPS) receiver 113.

The CPU 114 is a processor that controls operations of various modules of the smart phone 100. First, the CPU 114 executes a basic input/output System (BIOS) stored in the BIOS-ROM 105.

Thereafter, the CPU 114 executes various computer programs loaded on the main memory 103 from the nonvolatile memory 106 as a storage device. The programs to be executed include an operating system (OS) 201 and various application programs. For example, the application programs include an image management program.

This image management program 202 has a function for managing image data acquired by the camera module 109, image data stored in the nonvolatile memory 106, image data obtained from an external storage medium or an external storage device (imported image data), and the like. In addition, the image management program 202 may have a function for managing image data stored on a server provided as a cloud service and the like (via a communication network).

The system controller 102 is a device that connects between a local bus of the CPU 114 and various components. The system controller 102 incorporates a memory controller that performs access control on the main memory 103. The system controller 102 has a function to communicate with the graphics controller 104 via a serial bus based on the PCI EXPRESS standard, and the like.

The graphics controller 104 is a display controller that controls an LCD 110A used as a display monitor of the smart phone 100. The graphics controller 104 generates and transmits a display signal to the LCD 110A. The LCD 110A displays screen data based on the display signal. A touch panel 110B is arranged on the LCD 110A.

The wireless communication device 107 is a device configured to perform wireless communication such as a wireless LAN or Bluetooth (registered trademark). The EC 108 is a one-chip microcomputer comprising an embedded controller for managing a power supply. The EC 108 has a function to turn on and off a power supply of the smart phone 100 according to an operation on a power button made by a user.

For example, the camera module 109 acquires image data in response to a user touching (tapping) a button (graphical object) displayed on the screen of the touch screen display 110. The speaker module 112 outputs voice based on a voice signal.

The telephone line communication module 111 is a module for performing data communication including voice data via a base station that relays networks provided as a mobile communication system such as the third generation (3G).

The base station is provided to perform communication with an electronic device comprising the telephone line communication module 111 in a communicable area. Accordingly, to enable the surface of the Earth communicable, the base station is provided by area units divided on the basis of a (communicable) range where radio waves can reach on the surface of the Earth.

Then the telephone line communication module 111 detects radio waves emitted from the base station and communicates with the base station. The telephone line communication module 111 can switch abase station to be connected (hereinafter, referred to as handover) according to the movement of the smart phone 100.

The GPS receiver 113 receives positional information of the smart phone 100 measured by a GPS.

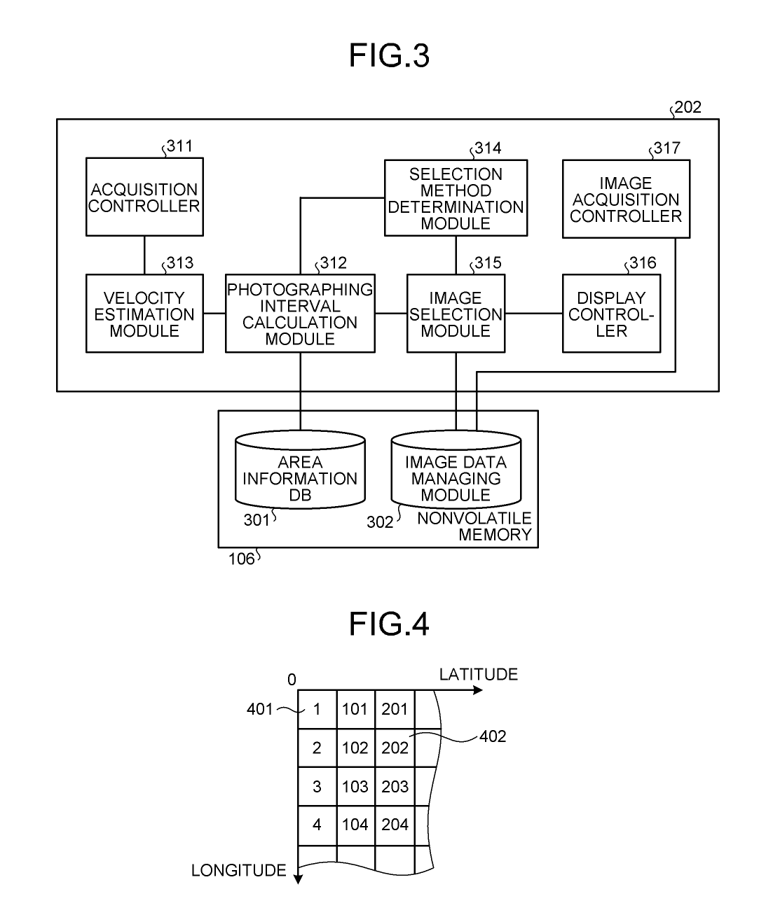

FIG. 3 is a diagram illustrating a software configuration implemented by the smart phone 100 in the first embodiment. The smart phone 100 can implement the configuration illustrated in FIG. 3 when the CPU 114 executes the image management program 202.

As illustrated in FIG. 3, the image management program 202 comprises an acquisition controller 311, a photographing interval calculation module 312, a velocity estimation module 313, a selection method determination module 314, an image selection module 315, a display controller 316, and an image acquisition controller 317. Each component in the image management program 202 refers to an area information DB (database) 301 and an image data managing module 302 stored in the nonvolatile memory 106.

The image management program 202 in the first embodiment displays image data acquired by the camera module 109 so far (hereinafter, referred to as acquired image data) to the user according to an area in which the user is present (area in which the smart phone 100 carried by the user is present).

A display condition is such that the image management program 202 displays the acquired image data based on intervals at which photographs are taken in the area in which the user is present. That is, when the user enters an area, if the number of elapsed days between the current date and time and a date and time closer to the current time, either the date and time at which a photograph is taken last in the area or the date and time at which the acquired image data is displayed last in the area, is larger than a photographing interval in the area, the image management program 202 displays the acquired image data acquired in the area to the user.

The photographing interval in the area is proportional to a level of the user's interest in the area. In other words, if the user takes photographs in the area very often (intervals of dates at which photographs are taken in the area are very short), it is considered that the user's interest in the area is high. Accordingly, the image management program 202 performs control to shorten intervals of displaying the image data acquired in the area.

Conventionally, although it is easy to display the acquired image data photographed around the current position of the user, it is bothersome for the user if the acquired image data is displayed every time the user visits the location.

For example, it may be bothersome for some user if photographs are displayed every time the user visits a place where the user often visits (passes every day commute) but has little interest therein (not so many photographs are taken if the location is incidentally visited for the purpose of, for example, drinking).

Some other users may be unsatisfied if the acquired image data is not displayed at a place where the user often visits, even if they have not recently taken photographs. Some other users may desire the acquired image data to be displayed when they arrive at a destination because it is annoying that the acquired image data is displayed at a place where they have no plan to stop by.

As described above, the frequency of displaying acquired image data desired by a user depends on the user's interest or the like in that area. Therefore, the user's preference is not met only by displaying the acquired image data at predetermined intervals, as conventionally done.

Accordingly, the image management program 202 in the first embodiment displays acquired image data based on the user's interest (a photographing interval) in an area.

FIG. 4 is a diagram illustrating an example of area division in the first embodiment. In the example illustrated in FIG. 4, the latitude and longitude of the present location are projected on a plane with the Mercator projection, and the surface of the Earth is divided into areas having a predetermined size on the projected plane. Area IDs for identifying the areas are assigned thereto. For example, the area ID of an area 401 is “1”, and the area ID of an area 402 is “202”. The first embodiment describes an example of the area division. Alternatively, other methods may be used as long as it is a projection method in which any point on the surface of the Earth necessarily corresponds to one of the areas.

A unit of the area division may be set according to an aspect of implementation. For example, the unit may be 500 m, which is the minimum range that an outdoor cell for a cellular phone can transmit radio waves.

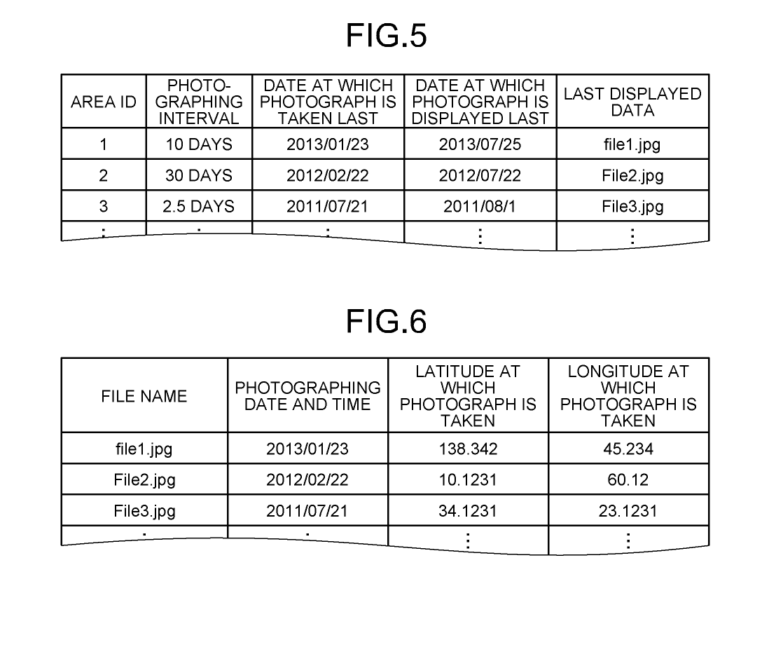

The area information DB (database) 301 is a database that manages information for each area. FIG. 5 is a diagram illustrating an example of the table structure of the area information DB. In the example illustrated in FIG. 5, the area ID, the photographing interval, the date (date and time) at which a photograph is taken last, the date (date and time) at which image data is displayed last, and the piece of last displayed (acquired image) data are associated with each other. The photographing interval is an average of intervals between the dates at which the photographs are taken. In the first embodiment, weighting or the like is not performed based on the number of photographs taken in one day. The piece of last displayed data is a piece of acquired image data on which the image management program 202 of the smart phone 100 lastly performs display control.

The image data managing module 302 is a database that manages information of image data acquired by the smart phone 100. FIG. 6 is a diagram illustrating an example of the table structure of the image data managing module 302 in the first embodiment. In the example illustrated in FIG. 6, a file name, a photographing date and time, a latitude at which a photograph is taken, and a longitude at which a photograph is taken, are associated with each other. The image data managing module 302 is updated by the image acquisition controller 317 to be described later each time photographs are taken. The first embodiment describes an example of holding a photographing date and time as information related to a date and time at which photographs are taken. Detailed time may also be included therein. The first embodiment describes an example of holding latitudes and longitudes as information related to a position at which the photographs are taken. However, the information to be held is not limited to the latitudes and the longitudes. Any information that can specify the position may be used.

As described above, an area is a region obtained by dividing the surface of the Earth by a predetermined size. Therefore, an area in which image data is acquired may be specified by associating and holding the latitude at which the photograph is taken and the longitude at which the photograph is taken with each acquired image data.

Returning to FIG. 3, the acquisition controller 311 acquires information of the position at which the smart phone 100 is present (hereinafter, referred to as positional information). The acquisition controller 311 according to the first embodiment is activated by switching (handover) of the base station (outdoor cell) and acquires the positional information. A method of acquiring the positional information is not limited to the method triggered by the handover. Alternatively, the image management program 202 may reside and continue to acquire the positional information. The acquisition destination of the positional information may be the GPS receiver 113 or the base station (outdoor cell).

The velocity estimation module 313 estimates the velocity of the smart phone 100 based on the amount of change in the positional information acquired by the acquisition controller 311.

When the velocity is equal to or higher than a predetermined velocity, it is considered that the user carrying the smart phone 100 is walking toward a destination, using transportation such as a train, or driving a car and the like, so that the user cannot afford to look at the smart phone 100 and does not have an interest in acquired image data at a place that is not the destination. Accordingly, in the first embodiment, acquired image data is displayed only when the velocity is lower than the predetermined velocity. It can be considered, as the timing at which the velocity becomes lower than the predetermined velocity, the case in which the transportation such as a train stops at a station or the case in which a car stops and waits for a traffic light to change. Accordingly, in the first embodiment, control may be performed so that the acquired image data is displayed when a definite time or more is elapsed after the velocity becomes lower than the predetermined velocity.

In the first embodiment, the predetermined velocity is set to 4 km/h, which is the average walking speed of a human being. That is, when an estimated velocity is lower than 4 km/h, the velocity estimation module 313 assumes that the user substantially stops, and performs processing to display acquired image data to the user. The velocity estimation module 313 in the first embodiment specifies an area ID representing the current area based on the positional information acquired by the acquisition controller 311, communication with a base station (outdoor cell) that is currently communicable, and the like. Then the velocity estimation module 313 passes the specified area ID to the photographing interval calculation module 312.

When the estimated velocity is determined to be equal to or higher than 4 km/h, the velocity estimation module 313 does nothing until the next handover occurs.

The photographing interval calculation module 312 reads, from the area information DB 301, information about the area in which the smart phone 100 is present based on the area ID passed from the velocity estimation module 313. Accordingly, the photographing interval calculation module 312 recognizes the photographing interval, the date (date and time) at which the photograph is taken last, the date (date and time) at which image data is displayed last, and the piece of last displayed acquired image data of the area in which the smart phone 100 is present (in other words, the user is currently present).

The photographing interval calculation module 312 compares the date and time of the image data acquired in the area in which the smart phone 100 is currently present among the acquired image data stored in the image data managing module 302 with the date and time at which the photograph is taken last in the area information DB 301. When there is a piece of acquired image data acquired at a date and time later than the date and time at which the photograph is taken last in the area information DB 301, the photographing interval calculation module 312 calculates the photographing interval again. When the photographing interval is not set, the photographing interval calculation module 312 calculates the photographing interval in a similar manner. As described above, having determined that the photographing interval needs to be calculated, the photographing interval calculation module 312 calculates the mean value of intervals of photographing dates from the photographing dates and times in the area, and sets it as the photographing interval of the area and updates the area information DB 301.

The selection method determination module 314 calculates a difference (elapsed time) between the latest date and time, which is either the date and time at which the photograph is taken last in the area or the date and time at which the data is displayed last in the area, and the current date and time, from information about the area in which the smart phone 100 is present. Then the selection method determination module 314 compares the calculated difference (elapsed time) with the photographing interval in the area. Having determined that the calculated difference is equal to or larger than the photographing interval, the selection method determination module 314 determines to display the acquired image data and determines a selection method of the acquired image data based on the photographing interval. Having determined that the calculated difference is smaller than the photographing interval, the selection method determination module 314 does not perform any processing in the area.

As the selection method of the acquired image data, different methods are used according to the photographing interval. In the first embodiment, different selection methods are applied depending on the photographing interval in the area of less than one week, one week or more and less than one month, and one month or more.

For example, when the photographing interval in the area in which the smart phone 100 is currently present is less than one week, the selection method determination module 314 sets to display image data acquired on a day that is before the current day and the same day of the week as the current day. By using such a selection method, the acquired image data corresponding to the current situation may be provided with unpredictability. When there is no such acquired image data, the selection method determination module 314 sets to select the latest acquired image data among image data acquired in the area.

When the photographing interval in the area in which the smart phone 100 is currently present is one week or more and less than one month, the selection method determination module 314 sets to display the image data previously acquired at the same date and time as the current day. When there is no acquired image data meeting such a condition, the selection method determination module 314 sets to select image data acquired on a day different from the current day but in the same month as the current day. In addition, when there is no acquired image data meeting such a condition, the selection method determination module 314 sets to select the latest acquired image data in the area. It is considered that the user's memory is clear to some extent at a place to which the user goes every week. The first embodiment may provide unpredictability to the user by selecting acquired image data other than the latest.

When the photographing interval in the area in which the smart phone 100 is currently present is one month or more, the selection method determination module 314 sets to display the latest acquired image data in the area. By displaying the acquired image data remaining in the user's memory in most cases, it is possible to remind the user that the user has visited the area in the past.

As described above, the selection method determination module 314 in the first embodiment causes the selection method of the acquired image data that is to be displayed, to be different according to the level of interest of the user in the area. By causing the selection method in an area in which the photographs are frequently taken to be different from the selection method in an area in which photographs are rarely taken, it is possible to display the acquired image data in which the user has more interest.

The image selection module 315 selects acquired image data to be displayed from acquired image data photographed in the area in which the smart phone 100 is currently present and stored in the image data managing module 302 based on the selection method of an image set by the selection method determination module 314. When there is a plurality of pieces of acquired image data meeting the display condition, the image selection module 315 randomly selects one piece of the acquired image data. The image selection module 315 may perform control so that a piece of acquired image data photographed on the current day is not selected.

The display controller 316 displays acquired image data selected by the image selection module 315. The first embodiment allows display of image data acquired in the area including the positional information (in which the smart phone 100 is currently present) acquired by the acquisition controller 311, based on the photographing interval by the camera module 109 in the area including the positional information acquired by the acquisition controller 311, by displaying the acquired image data selected by the image selection module 315. The acquired image data to be displayed is acquired image data stored in the nonvolatile memory 106.

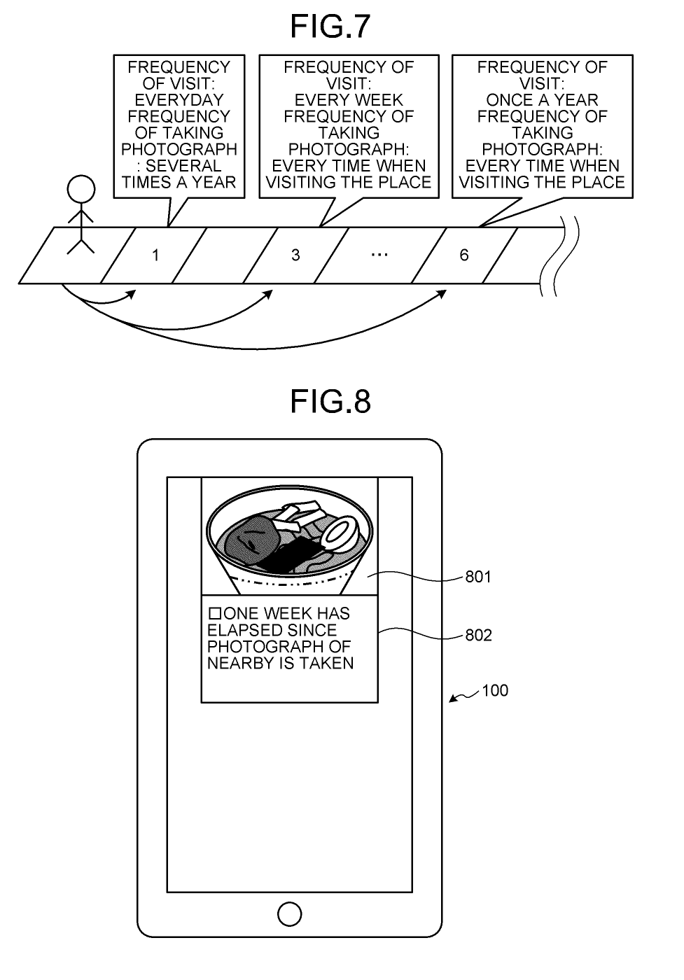

FIG. 7 is a diagram illustrating an example of the frequency of visit and the photographing interval of the smart phone 100 in the first embodiment. When the user visits an area “1” illustrated in FIG. 7, the display controller 316 of the smart phone 100 displays acquired image data only several times a year because the photographing interval therein is several times a year although the user visits the area every day. When the user visits an area “3”, the display controller 316 of the smart phone 100 displays acquired image data every week because the user visits the area every week and takes photographs every time. When the user visits an area “6”, the display controller 316 of the smart phone 100 displays acquired image data every time the user visits the area “6”, because the user visits the area only once a year but takes photographs every time.

In the first embodiment, when the image management program 202 operates in the background, the display controller 316 displays acquired image data using a notification function of the OS 201, having been triggered by handover.

FIG. 8 is a diagram illustrating an example of a screen displayed by the display controller 316 in the first embodiment. As illustrated in FIG. 8, when the outdoor cell is switched, the display controller 316 displays acquired image data 801 photographed in the area covered by the switched outdoor cell. At the same time, text 802 and the like may be displayed for displaying the photographing interval and the like. This may improve the user's motivation to photography.

The display controller 316 performs display control based on the velocity. In the first embodiment, acquired image data is displayed when the velocity of the smart phone 100 becomes equal to or lower than the walking speed of the user (for example, 4 km/h).

After the display controller 316 performs display control on the acquired image data, in the area information DB 301, “date at which photograph is displayed last” of the record corresponding to the current area is updated to the date and time of the current day, and “last displayed data” is updated to the file name of a piece of acquired image data currently displayed.

Upon receipt of the selection of the displayed image data from the user, the display controller 316 may display a list of acquired image data photographed in the same area.

The information displayed along with the acquired image data is not limited to the text 802 described above, and the display controller 316 may display various types of information. For example, the display controller 316 may display information about a neighborhood store or a coupon that can be used in the neighborhood store, as the information related to the acquired image data to be displayed.

The display controller 316 may analyze the acquired image data to be displayed and display information corresponding to contents of the analyzed data. If a store or a specific building may be recognized in the acquired image data, the display controller 316 may guide the user to the store. Only if food is recognized in the acquired image data, the display controller 316 may display a coupon and the like.

When the display controller 316 displays the acquired image data, the smart phone 100 may notify the user that the acquired image data is displayed by using a vibration function or sounding an incoming call.

The display controller 316 may limit the number of display times of the acquired image data for each day in one area. For example, the number of display times in the same area may be limited to once per day.

The image acquisition controller 317 performs imaging by controlling the camera module 109, and generates image data. The record of the file name of the acquired image data generated is added to the image data managing module 302. At the same time, the image acquisition controller 317 associates the file name of the acquired image data, photographing time (including a date and time), a latitude at which the photograph is taken, and a longitude at which the photograph is taken with the acquired image data, and stores them in the image data managing module 302. The latitude and longitude indicate the present position received by the GPS receiver 113.

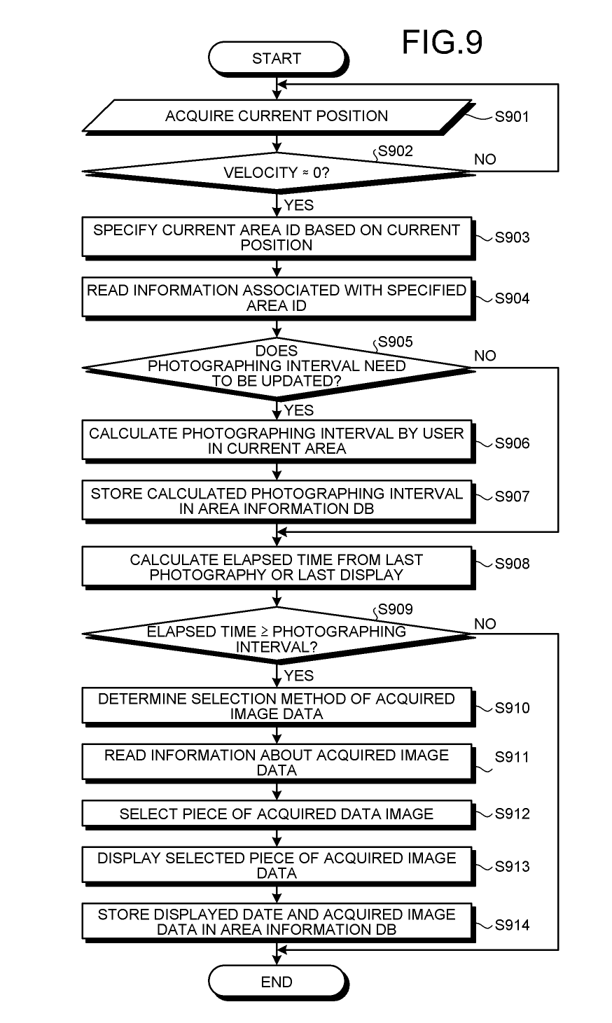

The following describes the display process of acquired image data in the smart phone 100 according to the first embodiment. FIG. 9 is a flowchart of the process described above in the smart phone 100 in the first embodiment.

The acquisition controller 311 acquires current positional information of the smart phone 100 (S901). Next, the velocity estimation module 313 estimates the velocity of the smart phone 100 based on the amount of change in the positional information acquired by the acquisition controller 311, and determines whether the velocity is almost zero (S902). If it is determined that the velocity is not almost zero (No at S902), the process returns to S901.

If the velocity estimation module 313 determines that the velocity is almost zero (Yes at S902), the area ID indicating the current area is specified from the current positional information (S903).

Thereafter, the photographing interval calculation module 312 reads information about the area associated with the specified area ID from the area information DB 301 (S904).

Then, the photographing interval calculation module 312 determines whether the photographing interval needs to be updated in the read information about the area (S905). If it is determined that the photographing interval does not need to be updated (No at S905), the process proceeds to S908.

If the photographing interval calculation module 312 determines that the photographing interval needs to be updated (Yes at S905), the photographing interval calculation module 312 calculates the photographing interval of the smart phone 100 in the current area (S906).

Then the photographing interval calculation module 312 associates the calculated photographing interval with the area ID indicating the current area to be stored in the area information DB 301 (S907).

Thereafter, the selection method determination module 314 calculates elapsed time from the last photograph or the last display in the current area to the current time (S908).

Then the photographing interval calculation module 312 determines whether the elapsed time is equal to or longer than the photographing interval (S909). If it is determined that the elapsed time is shorter than the photographing interval (No at S909), the process finishes.

If the photographing interval calculation module 312 determines that the elapsed time is equal to or longer than the photographing interval (Yes at S909), the photographing interval calculation module 312 determines the selection method of the imaged image data (S910).

Thereafter, the image selection module 315 reads information about the acquired image data from the image data managing module 302 (S911). The read information comprises the latitudes and longitudes, so that the acquired image data photographed in the current area is extracted.

Then the image selection module 315 selects a piece of acquired image data to be displayed among the extracted pieces of acquired image data with the determined selection method (S912).

Then, the display controller 316 displays the selected piece of imaged image data (S913). The display controller 316 also updates the area information DB 301 using the displayed date and time and the displayed piece of imaged image data (S914).

According to the process procedure described above, it is possible to display the acquired image data photographed in the past at the place where the user is currently present.

### Second Embodiment

The first embodiment describes an example of displaying acquired image data according to the photographing interval by the user for each area. However, the trigger for displaying the acquired image data used by the image management program 202 is not limited to the photographing interval. A second embodiment describes an example of displaying the acquired image data using a scheduler.

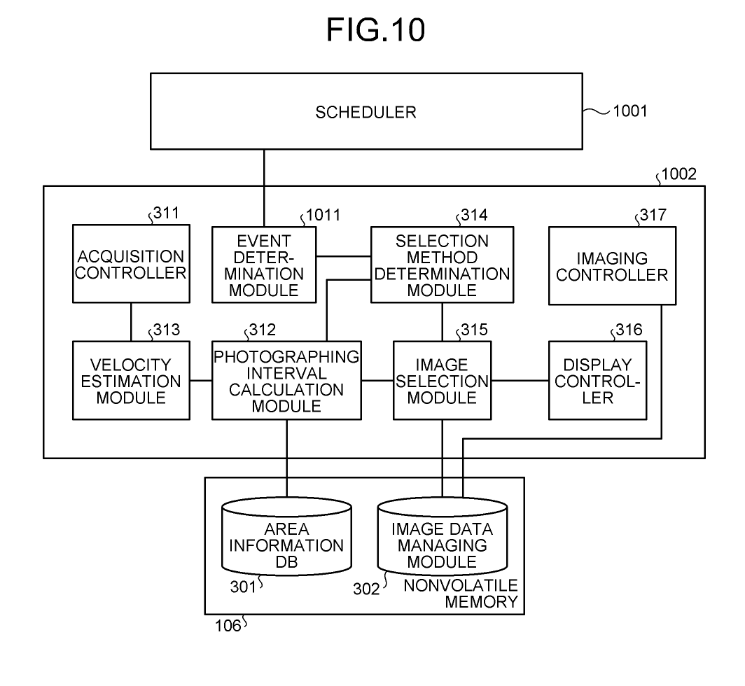

FIG. 10 is a diagram illustrating a software configuration implemented by the smart phone 100 according to the second embodiment. The smart phone 100 may implement the configuration illustrated in FIG. 10 when the CPU 114 executes an image management program 1002.

The smart phone 100 according to the second embodiment is different from the first embodiment described above in that a scheduler 1001 is added and a new configuration is added to the image management program 1002. Hereinafter, the same components as those in the first embodiment described above are denoted by the same reference numerals as in the first embodiment, and the description thereof is not repeated there.

The scheduler 1001 manages information about events performed by a user for each day. The event information is associated with time when the event is performed and a place where the event is performed.

The image management program 1002 has a configuration in which an event determination module 1011 is added to the image management program 202.

The event determination module 1011 determines whether to display acquired image data based on a current date, a date and time at which the event indicated by the event information managed by the scheduler 1001 is set, positional information acquired by the acquisition controller 311, and an area in which the event indicated by the event information is performed. The event determination module 1011 in the second embodiment determines whether the event information is set at the current date. If it is determined that the event information is set at the current date, the event determination module 1011 further determines whether the positional information acquired by the acquisition controller 311 and a place indicated by the event information are in the same area. If the event determination module 1011 determines that they are in the same area, the event determination module 1011 determines to display image data acquired in the area.

Thereafter, the selection method determination module 314 determines the selection method of the acquired image data based on the photographing interval in the area. The method for determining the selection method is similar to that in the first embodiment, so that description thereof is not repeated here.

In the second embodiment, the smart phone 100 comprises the configuration as described above, so that the acquired image data based on a schedule may be provided to the user.

Conventionally, the frequency of reviewing the acquired image data is low even if many photographs are taken. In contrast, in the above embodiments, the smart phone 100 can display the acquired image data photographed in the past to a user at the timing when the user might show interest in the data, by executing the image management programs 202 and 1002. This provides the user with an opportunity for enjoying the acquired image data photographed in the past.

In recent years, mobile terminals and digital cameras tend to comprise a GPS receiver, and associate and record information about a photographing spot with acquired data when photographs are taken. Accordingly, when a user visits a place where the user takes photographs in the past, the smart phone 100 according to the above embodiments displays the acquired image data photographed in the past at the same place to provide an opportunity for promoting a subsequent action of the user.

In the above embodiments, the acquired image data is displayed by acquiring the positional information at timing of handover, so that power consumption may be reduced as compared to a case in which a computer program resides.

In the above embodiments, the acquired image data is displayed according to the photographing interval, so that the acquired image data estimated to attract the user's interest can be automatically displayed to the extent not being bothersome to the user.

In the above embodiments, the acquired image data is displayed only when the velocity is equal to or lower than a predetermined velocity, so that the acquired image data can be prevented from being displayed while using a train or a car. The acquired image data can be also prevented from being displayed when the user only passes by a place other than a destination.

In the above embodiments, the acquired image data can be prevented from being frequently displayed at a place where the user often goes while commuting but does not take photographs very often. In contrast, at a place where the user visits after a long interval, a photograph taken in the past can be securely displayed as recommendation.

In the above embodiments, the acquired image data is displayed based on the frequency of photography by the user, so that the acquired image data can be displayed in proportion to the level of interest of the user in a place. For example, when the user visits a place where the user rarely has a chance to take photographs, the acquired image data can be prevented from being excessively displayed. As described above, in the above embodiments, the acquired image data can be displayed at timing corresponding to the user.

The image management programs 202 and 1002 executed in the smart phone 100 in the above embodiments are provided as an installable file or an executable file, being recorded in a computer-readable recording medium such as a CD-ROM, a flexible disk (FD), a CD-R, and a digital versatile disk (DVD).

The image management programs 202 and 1002 executed in the smart phone 100 in the above embodiments may be provided by being stored on a computer connected to a network such as the Internet and downloaded via the network. The image management programs 202 and 1002 executed in the smart phone 100 in the above embodiments may also be provided or distributed via a network such as the Internet.

The image management programs 202, 1002 in the above embodiments may be provided by being incorporated in a ROM and the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
storing image data acquired by a camera in an electronic device, first information regarding a date and time at which the image data is acquired, and second information regarding a position at which the image data is acquired;
acquiring third information regarding a first position at which the electronic device is present; and
displaying, when the electronic device is in a first region comprising the first position, first image data acquired by the camera in the first region based on a photographing interval in the first region.

2. The method of claim 1, wherein the image data is displayed when a velocity of the electronic device is equal to or lower than a first velocity.

3. The method of claim 1, wherein the image data is displayed based on the photographing interval in the first region and time length from a latest date and time of the image data photographed in the first region to a current time.

4. The method of claim 1, wherein the image data is displayed based on the photographing interval in the first region and time length from a first date and time at which the image data is displayed last in the first region to a current time.

5. The method of claim 1, further comprising:
managing fourth information regarding a first date and time at which an event is performed and information regarding a second position at which the event is performed, wherein
the image data is displayed based on a current date and time, the first date and time at which the event is performed, the first position, and the second position at which the event is performed.

6. An electronic device comprising:
storage comprising image data acquired by a camera, first information regarding a date and time at which the image data is acquired, and second information regarding a position at which the image data is acquired;
a processor configured to acquire third information about a first position at which the electronic device is present; and
a display controller configured to display, when the electronic device is in a first region comprising the first position, first image data acquired by the camera in the first region based on a photographing interval in the first region.

7. The electronic device of claim 6, wherein the display controller is configured to display the image data when a velocity of the electronic device is equal to or lower than a first velocity.

8. The electronic device of claim 6, wherein the display controller is configured to display the image data based on the photographing interval in the first region and time length from a latest date and time of the image data photographed in the first region to a current time.

9. The electronic device of claim 6, wherein the display controller is configured to display the image data based on the photographing interval in the first region and time length from a first date and time at which the image data is displayed last in the first region to a current time.

10. The electronic device of any one of claim 6, further comprising:
a scheduler configured to manage fourth information regarding a first date and time at which an event is performed and fifth information regarding a second position at which the event is performed, wherein
the display controller is configured to display the image data based on a current date and time, the first date and time at which the event is performed, the first position, and the second position at which the event is performed.

11. A computer program product having a non-transitory computer readable medium including programmed instructions, wherein the instructions, when executed by a computer, cause the computer to perform:
storing image data acquired by a camera in the computer, first information regarding a date and time at which the image data is acquired, and second information regarding a position at which the image data is acquired;
acquiring third information about a first position at which the computer is present; and
displaying, when the electronic device is in a first region comprising the first position, first image data acquired by the camera in the first region based on a photographing interval in the first region.

12. The computer program product of claim 11, wherein the image data is displayed at the displaying when a velocity of the computer is equal to or lower than a first velocity.

13. The computer program product of claim 11, wherein the image data is displayed at the displaying based on the photographing interval in the first region and time length from a latest date and time of the image data photographed in the first region to a current time.

14. The computer program product of claim 11, wherein the image data is displayed at the displaying based on the photographing interval in the first region and time length from a first date and time at which the image data is displayed last in the first region to a current time.

15. The computer program product of claim 11 that causes the computer to further execute:
managing fourth information regarding a first date and time at which an event is performed and fifth information regarding a second position at which the event is performed, wherein
the image data is displayed at the displaying based on a current date and time, the first date and time at which the event is performed, the first position, and the second position at which the event is performed.
